(19) United States
(12) Patent Application Publication
(10) Pub. No.: US 2018/0042286 A1
(43) Pub. Date: Feb. 15, 2018

(54) C1 Sports Gel

(71) Applicant: Clarence Patrick Wheeler, Atlanta, GA (US)

(72) Inventor: Clarence Patrick Wheeler, Atlanta, GA (US)

(21) Appl. No.: 15/726,190

(22) Filed: Oct. 5, 2017

Related U.S. Application Data
(60) Provisional application No. 62/508,294, filed on May 18, 2017.

(51) Int. Cl. A23L 33/15; A23L 33/16

(52) U.S. Cl. CPC A23L 33/15; A23L 33/16; A23V 2002/00; A23V 2250/154; A23V 2250/032; A23V 2250/1578; A23V 2250/1582; A23V 2250/16; A23V 2250/1618; A23V 2250/1614; A23V 2250/161; A23V 2250/7052; A23V 2250/712; A23V 2250/71; A23V 2250/5022; A23V 2250/5102; A23V 2200/228; A23V 2200/32

(57) ABSTRACT

The present invention provides a flavored sports gel, which synergistically aids in energy production, such as in muscles and restores electrolytes. This product provides nutrients without any caffeine while retaining efficacy.

### CROSS-REFERENCES TO RELATED APPLICATIONS

Not Applicable.

### STATEMENT REGARDING FEDERALLY SPONSORED RESEARCH OR DEVELOPMENT

Not Applicable.

### MICROFICHE APPENDIX

Not Applicable

### BACKGROUND OF THE INVENTION

### 1. Field of the Invention.

This invention relates to the field of a flavored sports gel for athletes to be injected into a injectable mouthpiece.

### 2. Description of the Related Art.

There are many different types of supplements that vary from pill to liquid form. But the present invention seeks to provide a new sophisticated way of taking supplements in the sports world on and of the field.

### SUMMARY OF THE INVENTION

The invention comprises a flavored product sports gel and method of use thereof. The present invention particularly provides:

(1) a flavored sports gel composition comprising the following components on a percent weight to weight basis (% w/w)

| components | % weight to weight |
|---|---|
| purified water | |
| citric acid | |
| calcium chloride | |
| sodium chloride | |
| sodium citrate | |
| potassium phosphate | |
| magnesium citrate | |
| artificial colors | |
| natural flavors | |
| ascorbic acid (vitamin C) | |
| vitamin B | |
| vitamin E | |
| gum arabic | |
| isoglucose (artificial sugar) | |
| pectin | |

(2) a process for preparing the present invention comprising
(a) preparing all ingredients, each part containing components in the specified ranges, calculated on the basis of the final gel composition, expressed as percent weight-to-weight:

| | % w/w |
|---|---|
| Part 1 | |
| purified water | |
| sodium chloride | |
| potassium phosphate | |
| sodium citrate | |
| calcium chloride | |
| magnesium citrate | |
| Part 2 | |
| vitamin B | |
| vitamin E | |
| ascorbic acid (vitamin C) | |
| Part 3 | |
| citric acid | |
| natural flavors | |
| gum arabic | |
| Part 4 | |
| artificial color(s) | |
| Part 5 | |
| pectin | |
| Part 6 | |
| isoglucose (artificial sugar) | |

(b) adding Parts 1-3 and mixing; and subsequently,
(c) adding Part 4 to the mixture of Parts 1-3 to achieve the desired color(s).
(d) adding Part 5 and 6 to the mixture of Parts 1-4 until a uniform gel is obtained.

The present invention thus provides a novel, elegant means to digest the flavored sports gel. The present invention has not been previously described in any reference of which the inventor is aware of. Gels are semisolid systems consisting of either suspensions made up of small inorganic particles or large organic molecules interpenetrated by a liquid. Single phase gels, as used herein, consist of organic macromolecules uniformly distributed throughout a liquid in such a manner that no apparent boundaries exist between the dispersed macromolecules and the liquid. Single-phase may be made from synthetic or natural gums and pectin. The process used to prepare the present invention proceeds as follows:

These components are prepared and are mixed as described below. “Please note that the listed weight portions are projected on a 6 quart scale and are or can be modified subject to change depending on size of mixing container(s)”.

Part 1 contains 192 fl oz of purified water, which has been purified to remove any chemicals or contaminants, sodium chloride, potassium phosphate, sodium citrate, calcium chloride, and magnesium citrate these five “electrolyte sources” together totaling in the range of 3.1 tablespoons combined, these four “electrolyte sources” are basically mixed into the purified water and stirred. A second part is prepared containing vitamin B in the range of 2 grams, vitamin E in the range of 1.3 grams, and vitamin C in the range of 2 grams, these are all in a powder form mixed together then poured into part 1 stirred and shaken. A third part containing ruffly 6 fl oz's of citric acid (flavor preservative), 14 grams of natural flavors (calcium chloride) and 5 grams of gum arabic, all 3 components in part 3 are combined together poured into parts 1 and 2 stirred and shaken. Part 4 is prepared by pouring approximately 3 tablespoons of artificial color(s) into the already combined parts 1-3 depending on what color(s) that are trying to be achieved then stirred and shaken. Part 5 is mixed into parts 1-4 at approximately 90 fl oz's of liquid pectin. However, it is preferred that part 6, 6 cups of isoglucose (artificial sugar) is mixed into the kettle while parts 1-5 is at a full boil stirring constantly. All percents are expressed on a weight-to-weight basis.

Parts 2 and 3 are then mixed with Part 1 by conventional means then stirred, the pot is then heated at a very low temperature, Part 4 is then added to the mixture and stirred, followed by Part 5 stirred into the mixture, the mixture is then brung to a vigorously boiled during this point part 6 is slowly added and stirred while the mixture is at a full rolling boil, boil for 1 to 2 minuets while stirring constantly. Remove kettle from heat, skim off foam with large metal spoon or other appropriate utensil. Immediately ladle into containers leaving ¼ inch space at top. Immediately cover containers with lids. Screw on firmly. Place containers in boiling water bath carefully setting containers on rack in canner or large sauce pot of boiling water. Water should cover containers by 1 to 2 inches. Cover canner and return the water to a boil for 5 minutes. Remove containers from canner. Store in a cool place until packaging. This process forms the gel like texture. A gel prepared using this process rather than conventional means allows the combination of otherwise incompatible ingredients, and facilitates carbomer dispersion manufacture. The ingredients in the present invention are those that the body uses in its metabolism of energy, electrolyte sources, and help prevents muscle cramps/stiffness. They work to synergistically balance use of B vitamins and superanitoxidants. Ultimately the result is abundant energy and less fatigue and more muscle with less fat. The health benefits vitamin C also known as ascorbic acids is one of the most effective and safest nutrients. It is a water soluble vitamin. A powerful antioxidants as well for the synthesis of collagen, which helps to make blood vessels and body muscles strong.

The human body doesn't have capacity to generate Vitamin C. Vitamin C plays a key role in the production of neurotransmitter like norepinephrine, as well as critical to the proper functioning of the brain. Vitamin E helps ease the pain of stiff muscles after exercise and during play as well as being a powerful antioxidant. Citric acids is an alkalizing agent that helps decrease acidity levels in body fluids. It also binds the excess calcium and allows it to leave the body. Gum arabic helps to reduce cholesterol levels. Isoglucose, or commonly called sugar, is an important energy source that is needed by all the cells and organs of our bodies. Some examples are our muscles and our brain. Electrolyte sources are good sources at helping your muscles contract and your nerves transmit impulses. They help your body maintain the proper fluid balance, and your kidneys work hard to keep electrolytes at the right level. Surprisingly and unexpectedly it has been found that the formulation parameters described herein produced a flavored gel with clarity and acceptable viscosity.

### DESCRIPTION OF THE PREFERRED EMBODIMENT(S)

The present invention is seen more fully by the Examples given below.

### Example 1

Preparation of the sports gel. “6 quart” yield.

C 1 sports gel are prepared by mixing the below-described 5 part mixtures:

% w/w

C 1 sports gel

| | |
|---|---|
| Part 1 | |
| purified water | 192 fl oz |
| sodium chloride | 9.22 mill |
| calcium chloride | 9.22 mill |
| sodium citrate | 9.22 mill |
| potassium phosphate | 9.22 mill |
| magnesium citrate | 9.22 mill |
| Part 2 | |
| vitamin B | 2 g |
| vitamin E | 1.3 g |
| ascorbic acid (vitamin C) | 2 g |
| Part 3 | |
| citric acid | 6 fl oz |
| natural flavors | 14 g |
| gum arabic | 5 g |
| Part 4 | |
| pectin | 90 fl oz |
| Part 5 | |
| artificial color(s) | 3 tbs |
| Part 6 | |
| isoglucose (artificial sugar) | 6 cup's |

In the above case, the component parts are prepared separately, Parts 1-3 are mixed together and heated. Part 4 is added to the heated mixture. Part 5 is then added. While at a full boil part 6 is then added until a uniform gel is obtained.

1. The said invention comprising the following components:

| components | Amount (% w/w) |
|---|---|
| purified water | 192 fl oz |
| citric acid | 6 fl oz |
| calcium chloride | 9.22 mill |
| potassium phosphate | 9.22 mill |
| sodium citrate | 9.22 mill |
| sodium chloride | 9.22 mill |
| magnesium citrate | 9.2 mill |
| natural flavors | 14 g |
| vitamin B6 | 1.3 g |
| vitamin E | 2 g |
| ascorbic acid (vitamin C) | 2 g |
| gum arabic | 5 g |
| pectin | 90 fl oz |
| isoglucose (artificial sugar) | 6 cup's |

2. When all said ingredients are combined stirred and heated the said invention should be in the uniform of a edible gel substance.

3. The said ingredients in the said invention help to promote energy production, restore electrolytes, helps to reduce muscle cramps/stiffness and is safe for digestion.
